(19) United States
(12) Patent Application Publication
(10) Pub. No.: US 2018/0274468 A1
(43) Pub. Date: Sep. 27, 2018

(54) VEHICLE EXHAUST SYSTEM

(71) Applicant: GM GLOBAL TECHNOLOGY OPERATIONS LLC, Detroit, MI (US)

(72) Inventors: Guangzhi A. Zhao, Troy, MI (US); Vincent J. Tylutki, Livonia, MI (US); Leo P. Craglow, Clarkston, MI (US)

(21) Appl. No.: 15/468,666

(22) Filed: Mar. 24, 2017

(51) Int. Cl. F02D 41/14; F01N 13/00; F01N 13/02; F01N 13/10; F02D 41/02; F01N 3/28

(52) U.S. Cl. CPC F02D 41/1454; F01N 13/008; F01N 13/02; F01N 3/28; F02D 41/1441; F02D 41/0235; F01N 13/10

(57) ABSTRACT

An exhaust system for a vehicle includes a catalytic converter, an exhaust manifold, an outlet sensor in addition to inlet and outlet pipes. The catalytic converter includes an integrated oxygen sensor mount, an entry, and an outlet. The integrated oxygen sensor mount operatively configured to receive an outlet sensor. The exhaust manifold may be operatively configured to couple a vehicle combustion chamber to the entry of the catalytic converter via a front pipe. The inlet sensor may be affixed to the front pipe upstream of the catalytic converter wherein the inlet sensor and the outlet sensor are in communication with an engine control module. The outlet pipe may be affixed to the outlet of the catalytic converter.

### TECHNICAL FIELD

This present disclosure relates generally to a vehicle exhaust system, and more particularly to an exhaust system which is optimized to better monitor and adjust the air fuel ratios in a vehicle engine.

### BACKGROUND

Internal combustion engines utilize feedback from Exhaust Gas Oxygen (EGO) sensors to maintain desired air-fuel ratio mixtures during combustion, at least under some conditions. The EGO sensors are part of the emissions control system and feeds data to the engine control module (ECM) to adjust the fuel to air ratio for the vehicle engine. Various types of EGO sensors may be used, such as linear type sensors, sometimes referred to as Universal Exhaust Gas Oxygen (UEGO) sensors, and switching type sensors such as Heated Exhaust Gas Oxygen (HEGO) and Exhaust Gas Oxygen (EGO) sensors, depending on whether a heater is included.

As is known, a vehicle engine burns gasoline in the presence of oxygen. It turns out that there is a particular ratio of air and gasoline that is “perfect,” and that ratio is 14.7:1. It is understood that different fuels may have different “perfect ratios”—the ratio depends on the amount of hydrogen and carbon found in a given amount of fuel. If there is less air than this perfect ratio, then there will be fuel left over after combustion. This is called a rich mixture. Rich mixtures are bad because the unburned fuel creates pollution. If there is more air than this perfect ratio, then there is excess oxygen. This is called a lean mixture. A lean mixture tends to produce more nitrogen-oxide pollutants, and, in some cases, it can cause poor performance and even engine damage.

Oxygen sensors are positioned in the exhaust pipe and can detect rich and lean mixtures in each of the engine cylinders. The mechanism in most sensors involves a chemical reaction that generates a voltage. The engine's computer looks at the voltage to determine if the mixture is rich or lean, and adjusts the amount of fuel entering the engine accordingly in order to make sure that all engine cylinders are operating correctly and under uniform conditions.

The reason why the engine needs the oxygen sensor is because the amount of oxygen that the engine can pull in depends on various things, such as the altitude, the temperature of the air, the temperature of the engine, the barometric pressure, the load on the engine, etc. In internal combustion engines equipped with an exhaust catalyst to reduce undesirable emissions, it has been found that modulation of the air-fuel ratio to rich and lean of stoichiometric conditions may also improve the efficiency of the catalyst under some conditions. One application of EGO sensors is to provide feedback upon which air-fuel ratios may be modulated. One prior approach involved modulating the air-fuel ratio using feedback from a Catalyst Monitor Sensor (CMS) such as a HEGO sensor to identify the stoichiometric conditions around which modulation was to take place.

Accordingly, it would be desirable in the industry to produce a vehicle exhaust system which is designed to provide accurate post O2 sensor data feedback to the engine control module in order to correctly modulate the air-fuel ratio.

### SUMMARY

Accordingly, the present disclosure provides an exhaust system for a vehicle having a catalytic converter, an exhaust manifold, an inlet sensor, an outlet sensor in addition to inlet and outlet pipes. The catalytic converter includes an integrated oxygen sensor mount, an entry, and an outlet. The integrated oxygen sensor mount may be operatively configured to mix the exhaust gas and may be configured to receive any one of a variety of oxygen sensors. The exhaust manifold is configured to couple a vehicle combustion chamber to the entry of the catalytic converter via a front pipe. The inlet oxygen sensor may be affixed to the front pipe upstream of the catalytic converter wherein the inlet oxygen sensor and the outlet oxygen sensor are in communication with an engine control module. The outlet pipe may be affixed to the outlet of the catalytic converter.

The present disclosure also contemplates the non-limiting example of an exhaust system having an exhaust manifold, a catalytic converter, a first catalytic converter pipe, a second catalytic converter pipe, an integrated oxygen sensor mount, and an engine control module wherein the integrated oxygen sensor mount is formed in at least one of the first catalytic converter pipe and the second catalytic converter pipe. The catalytic converter includes an inlet and an outlet. The first catalytic converter pipe may be affixed to the entry of the catalytic converter and the second catalytic converter pipe may be affixed to the outlet of the catalytic converter. The integrated sensor mount may be operatively configured to receive an oxygen sensor. The exhaust manifold may be operatively configured to couple a vehicle combustion chamber to the entry of the catalytic converter via the first catalytic converter pipe. The engine control module may be in communication with the oxygen sensor and a secondary oxygen sensor.

The present disclosure and its particular features and advantages will become more apparent from the following detailed description considered with reference to the accompanying drawings.

### BRIEF DESCRIPTION OF THE DRAWINGS

These and other features and advantages of the present disclosure will be apparent from the following detailed description of preferred embodiments, and best mode, appended claims, and accompanying drawings in which:

FIG. 1 is a schematic, non-limiting example view of a vehicle exhaust system in accordance with the present disclosure.

FIG. 2 is a schematic view of the electronic control module in communication with various embodiments of the vehicle exhaust system according to the present disclosure.

FIG. 3 is a perspective view of the catalytic converter having the oxygen sensor mount together with an example oxygen sensor in accordance with the present disclosure.

FIG, 4 is an enlarged perspective view of the integrated oxygen sensor mount on a catalytic converter of the present disclosure.

FIG. 5 illustrates an enlarged perspective view of the oxygen sensor mount implemented in either a first catalytic converter pipe, second catalytic converter pipe or a catalytic converter.

FIG. 6 is an upper isometric view of the integrated oxygen sensor mount of FIG. 3.

FIG. 7 is a cross sectional view of the threaded boss in FIG. 5 integrated oxygen sensor mount of FIG. 3.

FIG. 8 illustrates a cross section of another example, non-limiting embodiment of the integrated oxygen sensor mount implemented in a catalytic converter

FIG. 9 illustrates an enlarged perspective view of the oxygen sensor mount implemented in either a first catalytic converter pipe, second catalytic converter pipe or a catalytic converter.

Like reference numerals refer to like parts throughout the description of several views of the drawings.

### DETAILED DESCRIPTION OF THE PRESENT DISCLOSURE

Reference will now be made in detail to presently preferred compositions, embodiments and methods of the present disclosure, which constitute the best modes of practicing the present disclosure presently known to the inventors. The figures are not necessarily to scale. However, it is to be understood that the disclosed embodiments are merely exemplary of the present disclosure that may be embodied in various and alternative forms. Therefore, specific details disclosed herein are not to be interpreted as limiting, but merely as a representative basis for any aspect of the present disclosure and/or as a representative basis for teaching one skilled in the art to variously employ the present disclosure.

Except in the examples, or where otherwise expressly indicated, all numerical quantities in this description indicating amounts of material or conditions of reaction and/or use are to be understood as modified by the word “about” in describing the broadest scope of the present disclosure. Practice within the numerical limits stated is generally preferred. Also, unless expressly stated to the contrary: percent, “parts of,” and ratio values are by weight; the description of a group or class of materials as suitable or preferred for a given purpose in connection with the present disclosure implies that mixtures of any two or more of the members of the group or class are equally suitable or preferred; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this present disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

it must also be noted that, as used in the specification and the appended claims, the singular form “a,” “an,” and “the” comprise plural referents unless the context clearly indicates otherwise. For example, reference to a component in the singular is intended to comprise a plurality of components.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

The terms “comprising”, “consisting of”, and “consisting essentially of” can be alternatively used. Where one of these three terms is used, the presently disclosed and claimed subject matter can include the use of either of the other two terms.

Throughout this application, where publications are referenced, the disclosures of these publications in their entireties are hereby incorporated by reference into this application to more fully describe the state of the art to which this present disclosure pertains.

The following detailed description is merely exemplary in nature and is not intended to limit the present disclosure or the application and uses of the present disclosure. Furthermore, there is no intention to be bound by any theory presented in the preceding background or the following detailed description.

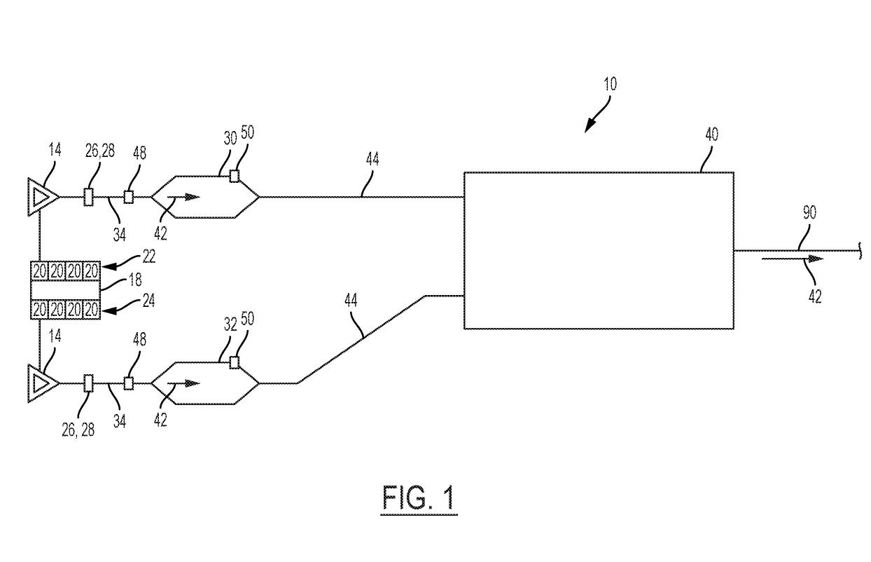

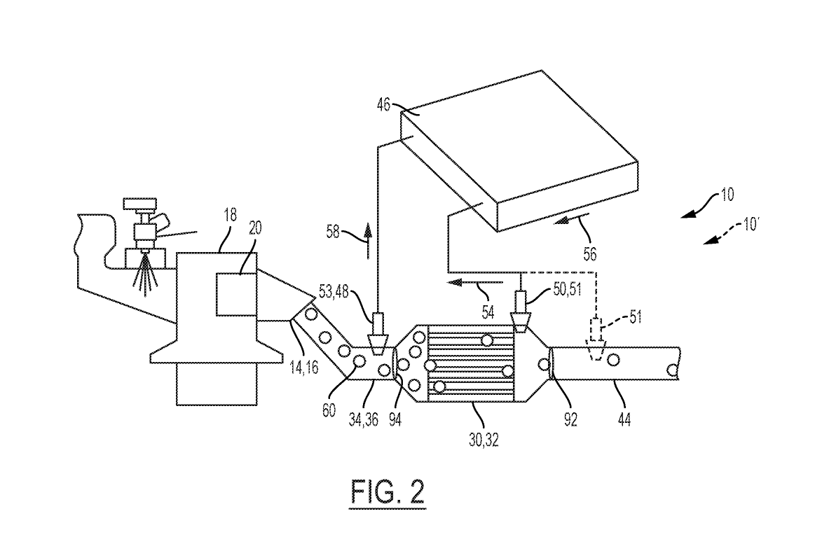

Referring now to FIGS. 1 and 2, schematic diagrams of an exhaust system 10 are shown in accordance with various embodiments of the present disclosure. An exhaust system 10 is connected to two banks 22, 24 of an engine 18 mounted on a vehicle. Each of those banks 22, 24 is connected to exhaust manifolds 14, 16 respectively to be communicated with a plurality of combustion chambers 20 provided at the respective banks 22, 24. As indicated, combustion engine 18 in FIGS. 1 and 2 may include a plurality of combustion chambers 20 which define the combustion spaces. In addition to the exhaust manifold 14, 16 which is coupled to the engine 18 at the combustion chambers 20, the exhaust system 10 may, but not necessarily, include a mixing chamber (collector 26) or a downpipe 28 as part of the system.

Each combustion chamber 20 in the engine 18 is connected to an exhaust manifold 14, 16, through which exhaust gases 42 from the combustion reaction in the combustion chambers 20 are transferred to a catalytic converter 30, 32. As previously noted, the exhaust manifold 14, 16 may be coupled to the engine 18 at the combustion chambers 20. The exhaust system 10 according to the present disclosure however is not restricted to combustion engines having a specific number of cylinders/chambers and can be used with various types of combustion engines.

Each of the exhaust manifolds 14, 16 is connected to corresponding front pipes, 34, 36 in which catalytic converters 30, 32 are provided for purifying the exhaust gas. A muffler 40 is provided downstream of the front pipe such that the respective portions of the front pipe 34, 36 may extend to the inside of the muffler 40. The muffler 40 is affixed to outlet pipe 44 where exhaust gases 42 are transmitted to the atmosphere.

In order to make sure that the vehicle engine 18 is provided the right mixture of air and fuel, an exhaust monitoring system 56 is implemented which includes an inlet oxygen sensor 48 (mounted at inlet/front pipe 34) as well as an outlet oxygen sensor 50 (mounted on a catalytic converter 30, 32) via integrated oxygen sensor mount 38. The inlet oxygen sensor 48 and/or outlet oxygen sensor 50 are responsible for keeping the air/fuel ratio of the mixture entering the engine 18 at the optimal level, which is approximately 14.7:1 or 14.7 parts of air to 1 part of fuel. When the inlet oxygen sensor 48 and/or outlet oxygen sensor 50 senses high level of oxygen content 60 (shown in FIG. 2), the engine control module (ECM) 46 assumes that the engine 18 is running lean (not enough fuel), so the ECM 46 adds fuel. When the level of oxygen in the exhaust becomes low, the ECM 46 assumes that the engine 18 is running rich (too much fuel) and reduces fuel supply.

The exhaust monitoring process is continuous. The ECM 46 and the engine 18 constantly cycles between slightly lean and slightly rich conditions to keep the air/fuel ratio at the optimum level. This process is called closed loop operation. With reference to FIG. 2, the ECM review of data from the inlet oxygen sensor voltage signal 58 and outlet oxygen sensor voltage signal 54 may demonstrate that the inlet/outlet oxygen sensors 48, 50 may be cycling somewhere between 0.2 Volts (Lean) and 0.9 Volts (Rich).

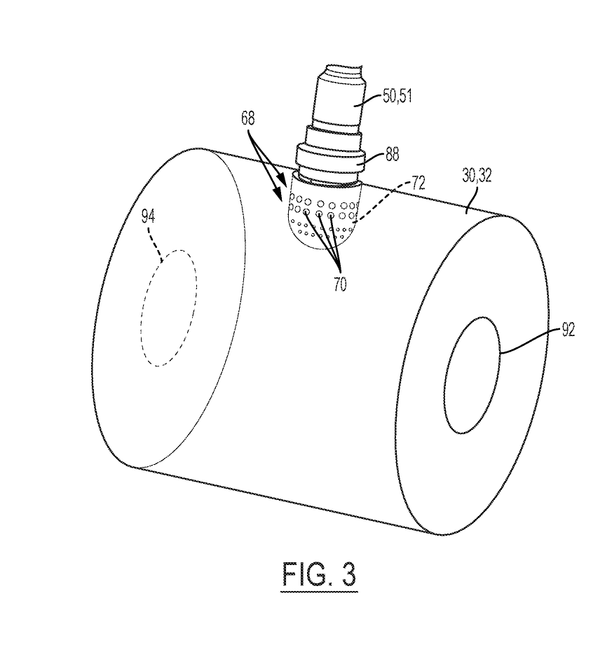

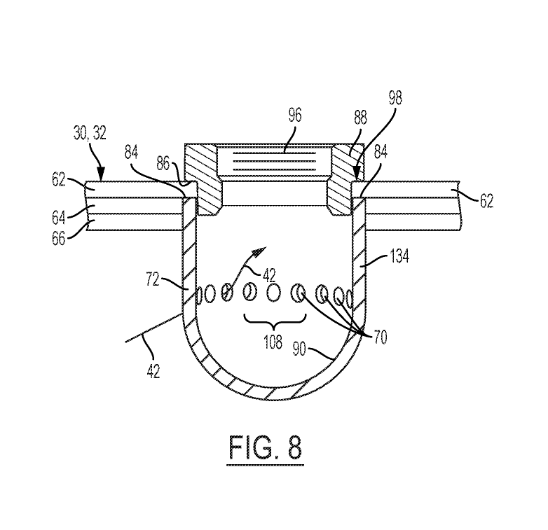

As shown ire schematic FIGS. 1, 2, and 8, a first embodiment of the present disclosure is shown wherein an inlet oxygen sensor 48 may be installed in the exhaust manifold 14, 16 or in the front exhaust pipe 34, 36 before the catalytic converter 30, 32. An outlet oxygen sensor 50 may be mounted in catalytic converter 30, 32 via an integrated sensor mount as shown in enlarged schematic view in FIGS. 3 and 8. With reference back to FIG. 1, V6 and V8 vehicles may have at least four oxygen sensors 48, 50 shown in total. It is also understood that cars with a 4-cylinder engine 18 have at least two oxygen sensors 48, 50. The engine computer (Engine Control Module or ECM 46) shown in FIG. 2 uses the output signal 58 from the inlet oxygen sensor 48 to adjust the air/fuel ratio by adding or subtracting fuel. The outlet oxygen sensor 50) transmits an output signal 54 is may also be used to monitor air/fuel ratio and/or the performance of the catalytic converter 30, 32.

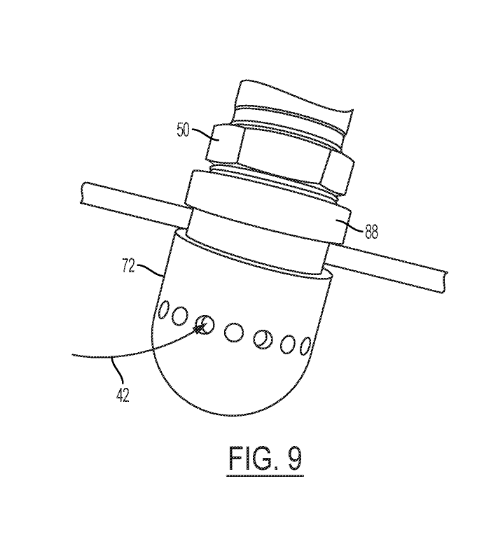

Outlet oxygen sensor 50 may be one of a variety of standard oxygen sensors which are commercially available in the automotive industry. The outlet oxygen sensor 50 may he received in the integrated oxygen sensor mount 38 and may measure the amount of oxygen 60 in the exhaust gases 42 via shroud 72 of the integrated oxygen mount 38. With reference to FIG. 9, the standard outlet oxygen sensor 51 may generally include a steel shell 78 having shell openings 82 around the sensing element 76. It is understood that the sensing element 76 of a standard oxygen sensor 51 may be formed from zirconium dioxide having an internal heating element 74. It is understood that shell openings 82 are generally defined across the sidewalk 80 of the steel shell 78 of a standard oxygen sensor 51.

Referring again to FIGS. 2 and 8, the exhaust gas 42 passes through the catalytic converter 30, 32 proximate to the sensing element 76, the signal 54 from the outlet oxygen sensor 50 is used to monitor the efficiency of the catalytic converter 30, 32 as well as measure the air fuel ratio in the exhaust gases 42. The exhaust gas 42 which flows proximate to the outlet oxygen sensor may he mixed via the apertures in the shroud as well as the apertures in the steel shell 78 of the outlet oxygen sensor. Accordingly, due to the mixing of the exhaust gas 42, the sensing element 76 may obtain accurate data for the ECM 46. The ECM 46 constantly compares the output signals 54, 58 from the inlet and the outlet oxygen sensors 48, 50. Based on the two signals, the ECM 46 knows how well the catalytic converter 30, 32 and/or the vehicle engine 18 is performing. For example, the data from the first and second oxygen sensors 48, 50 may be used to measure the air fuel ratios from each combustion chamber 20 so as to ensure that each combustion chamber 20 is operating under uniform conditions.

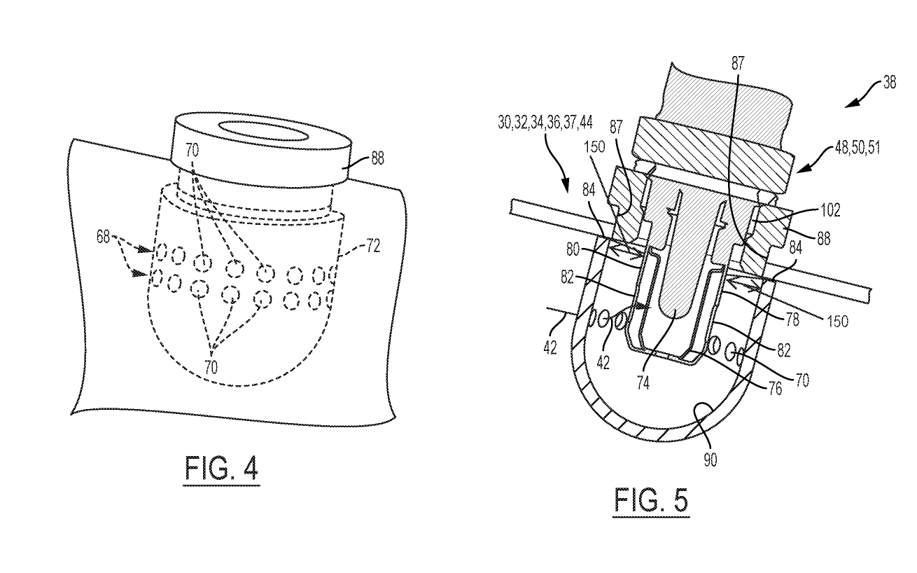

With reference to FIGS. 3-4 and 8-9, the catalytic converter 30, 32 may be described in greater detail wherein the catalytic converter 30, 32 includes an integrated oxygen sensor mount 38. FIG. 3 illustrates the catalytic converter 30, 32 with an example outlet oxygen sensor 50 installed in the integrated oxygen sensor mount 38. With reference to FIG. 8, the integrated outlet oxygen sensor mount 38 may be integrated with the shell 62, thermal layer 64, and/or substrate 66 of the catalytic convener 30, 32. The integrated oxygen sensor mount 38 includes a shroud 72 and a boss 88. The shroud 72 defines a recess 90 which may surrounds at least most of the sensing element 76 of the outlet oxygen sensor 50. In one embodiment, a boss 88 may be welded onto the shell of the catalytic converter 30, 32 wherein the boss 88 defines a threaded inner surface 96 on the interior of the boss 88. The sensor shroud 72 for the integrated oxygen mount may also be mounted directly to the boss 88 and/or the underside of shell a the catalytic convener 30, 32 (as shown in FIG. 5). At lower surface 86 (FIG. 8) or outer surface 87, the boss 88 may be welded to the surface of the shell 62.

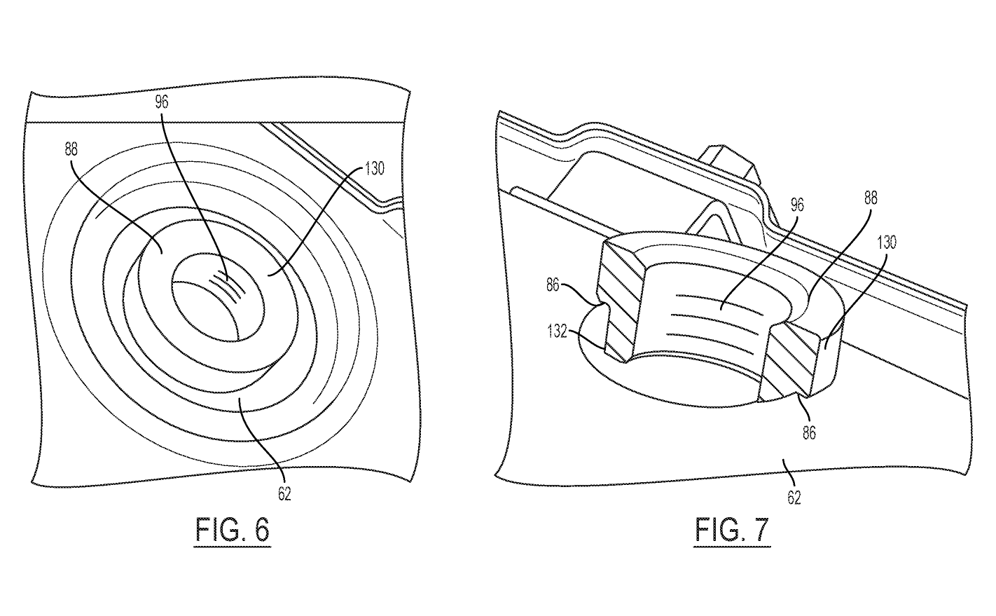

With reference to FIG. 6, an upper isometric view of the integrated oxygen sensor mount 38 of FIG. 3 is shown where the boss 88 is welded to the shell 62 of the catalytic converter 30, 32. As shown in FIGS. 6 and 7, the boss 88 may be a one piece member wherein an outer portion 130 of the boss 88 protrudes from the surface/shell of the catalytic convener 30, 32 and an inner portion 132 of the boss 88 extends below the shell and inside of the catalytic converter 30, 32. In FIG. 7, a cross sectional view of the threaded collar in FIG. 5 integrated oxygen sensor mount 38 is shown wherein the threaded inner surface 96 of the boss 88 is visible. With reference to FIGS. 6, 7 and 9 together, the threaded inner surface 96 of the boss 88 engages with the threads 102 of the outlet oxygen sensor 50 in order to affix the outlet oxygen sensor 50 in the appropriate position relative to the exhaust gases 42 flowing through the catalytic converter 30, 32. The lower surface 86 of the boss 88 (FIG. 8) or outer surface 87 of the boss 88 may engage with the shell 62 of the catalytic convener 30, 32 via a weld 98 in order to affix the boss 88 to the catalytic convener 30, 32. Accordingly, the sensing element 76 (FIG. 5) of the outlet oxygen sensor 50 may be suspended within the shroud so that the steel shell 78 (and shell openings 82) are spaced apart from the shroud 72 (and shroud apertures 70) by a distance 150 (shown in FIG. 5) of about 5 mm to 10 mm.

As shown in FIG. 3, the present disclosure contemplates an embodiment where two rows 68 of apertures may be defined in a shroud 72. While two rows 68 are shown in FIG. 3, it is understood that only one row 68 of apertures 70 may be defined in the shroud 72 (as shown in FIG. 5). It is also understood that as many as three or more rows 68 of apertures 70 may alternatively be defined in the shroud 72. The rows 68 of apertures 70 should be disposed substantially across from the sensing element of the oxygen sensor (as shown in FIG. 5). The spacing between the apertures 70 within each row may vary as well. Moreover, the spacing between each row of apertures 70 may also vary as well. While the apertures 70 shown in FIGS. 3-5 are circular, it is understood that the apertures 70 may come in a variety of shapes—squares, circles, ovals, etc. It is also understood that the apertures 70 of the shroud may be defined around the entire (100%) circumferential surface 120 or around only a portion or specific sections (<100%) of the circumferential surface 120 of the shroud 72. The size of the apertures may vary as web. Moreover, the apertures 70 of the shroud 72 may be defined over part or the entire circumferential surface 134 of the shroud in a non-linear fashion (not in rows) but keeping the apertures substantially disposed across from the sensing element of the oxygen sensor.

Noting that the apertures 70 in the shroud 72 may but not necessarily be spaced apart from the openings 82 in the sensor's steel shell 78 by a distance 150 (shown in FIG. 5) which falls within a range of approximately 5 mm to 10 mm. The exhaust gases 42 proximate to the outlet oxygen sensor may therefore flow through both the shroud apertures and steel shell openings 82 before the flow of exhaust gas 42 reaches the sensing element. As a result of having the exhaust gases 42 flow through both the shell openings 82 and the shroud apertures, the exhaust gases 42 may be mixed before they reach the sensing element. Therefore, the outlet oxygen sensor 50 may be able to accurately read the composition of the exhaust gas 42 flowing through the catalytic converter 30, 32.

Therefore, as a result of the swirling or turbulence in the exhaust gas flow 42 proximate to the outlet oxygen sensor 50 (which is mounted to the catalytic converter 30, 32) the exhaust system 10 of the present disclosure may obtain a more accurate reading of the oxygen 62 levels in the exhaust gas flow 42. Again, this vehicle exhaust system 10 arrangement may accommodate a variety of types of oxygen sensors from various oxygen sensor manufacturers thereby providing a cost-efficient system vehicle system for vehicle manufacturers. Accordingly, regardless of which type of oxygen sensor implemented, the vehicle exhaust system 10 of the present disclosure provides an improved detection rate for the outlet oxygen sensor 50.

With reference to FIGS. 2 and 5, the second embodiment of the present disclosure contemplates a vehicle exhaust system 10′ having an exhaust manifold 14, 16, a catalytic converter 30, 32, a first catalytic converter pipe 34, 36, a second catalytic converter pipe 44, an integrated oxygen sensor mount, and an engine control module Wherein the integrated oxygen sensor mount is formed in one of the first catalytic converter pipe 34, 36 and the second catalytic converter pipe 44. The catalytic converter 30, 32 includes an inlet 94 and an outlet 92. The first catalytic converter pipe 34, 36 (front pipes 34, 36) may be affixed to the inlet 94 of the catalytic converter 30, 32 and the second catalytic converter pipe 44 44 may be affixed to the outlet 92 of the catalytic converter 30, 32. The integrated sensor mount 36 may be operatively configured to receive an oxygen sensor 51. Oxygen sensor 51 may be an inlet oxygen sensor 48 if the oxygen sensor is mounted in the first catalytic converter pipe 34, 36, and/or oxygen sensor 51 may be an outlet oxygen sensor 50 if the oxygen sensor is mounted in the second catalytic converter pipe 44. The exhaust manifold 14, 16 may be operatively configured to couple a vehicle combustion chamber 20 to the inlet 94 of the catalytic converter 30, 32 via the first catalytic converter pipe 34, 36. The engine control module may be in communication with the oxygen sensor 51 and a secondary oxygen sensor 53 (on an opposite side of the catalytic converter) as shown in an example of FIG. 2 wherein oxygen sensor 51 is shown in phantom.

Similar to the first embodiment having an integrated sensor mount 38 in the catalytic converter 30, 32 shown in FIG. 3, at least one row 68 of apertures 70 may be defined in at least a sectioned-portion of a circumferential surface 134 of the shroud 72 or the entire circumferential surface 134 of the shroud 72. While the apertures 70 shown in FIG. 4 are circular, it is understood that the apertures 70 may come in a variety of shapes—squares, circles, ovals, etc., and the size of the apertures 70 may vary as well.

While one row 68 of apertures 70 are shown in FIG. 8, it is understood that only two or more rows 68 of apertures 70 may be defined in the shroud 72 (as shown in FIG. 5). The spacing between the apertures 70 within each row may vary as well. Moreover, the spacing between each row of apertures 70 may also vary as well. While the apertures 70 shown in FIGS. 3-5 are circular, it is understood that the apertures 70 may come in a variety of shapes—squares, circles, ovals, etc. It is also understood that the apertures 70 of the shroud 72 may be defined around the entire (100%) circumferential surface 120 or around only a portion 108 (FIG. 8) or specific sections (<100%) of the circumferential surface 120 of the shroud 72. Moreover, the apertures 70 of the shroud 72 may be defined over part or the entire circumferential surface of the shroud 72 in a non-linear fashion (not in rows) but keeping the apertures 70 substantially disposed across from the shell openings 82 and sensing element of the oxygen sensor. Regardless of the number or spacing or the arrangement of the apertures 70, the apertures 70 should be disposed substantially across from the sensing element 76 (shown in FIG. 5) of the oxygen sensor 50 so that the apertures 70 of the shroud 72 may cooperate with the openings 82 of the steel shell 78 of the oxygen sensor. Accordingly, the sensing element 76 (FIG. 5) may be suspended within the shroud so that shell 78 with openings 82 is spaced apart from the shroud 72 by a distance 150 (shown in FIG. 5) of about 5 mm to 10 mm.

Noting that the apertures 70 in the shroud 72 for the catalytic converter pipe 37 are spaced apart from the apertures 70 in the steel shell which surrounds the sensing element, it is understood that exhaust gases 42 proximate to the oxygen sensor may flow through both sets of apertures 70—shroud apertures 70 and steel shell openings 82. As a result of having the exhaust gases 42 flow through both sets of apertures 70 and openings 82, the exhaust gases 42 may be mixed before they reach the sensing element 76 (FIG. 5) when the sensor 51 is in a catalytic converter pipe 37—either the first pipe 34, 36 or the second pipe 44 or both. Therefore, the oxygen sensor 51 may be able to accurately read the composition of the exhaust gas 42 flowing proximate to the oxygen sensor 51.

As noted, as a result of the swirling or turbulence in the exhaust as flow 42 proximate to the oxygen sensor 51, the exhaust system 10 of the present disclosure may obtain a more accurate reading of the oxygen content levels in the exhaust gas flow 42. Similar to the first embodiment describing a catalytic converter having an integrated oxygen sensor mount 38, this vehicle exhaust system arrangement with a catalytic converter pipe 37 with an integrated oxygen sensor mount 38 may accommodate a variety of types of oxygen sensors from various oxygen sensor manufacturers thereby providing a cost-efficient system vehicle system for vehicle manufacturers. Accordingly, regardless of which type of oxygen sensor implemented, the vehicle exhaust system of the present disclosure provides an improved detection rate for any oxygen sensor 50, 50′ which may be implemented.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should he understood that various changes can be made in the function and arrangement of elements without departing from the scope of the disclosure as set forth in the appended claims and the legal equivalents thereof.

What is claimed is:

1. An exhaust system for a vehicle comprising:
a catalytic converter having an integrated oxygen sensor mount, an entry, and an outlet, the integrated oxygen sensor mount operatively configured to receive an outlet sensor;
an exhaust manifold operatively configured to couple a vehicle combustion chamber to the entry of the catalytic converter via a front pipe;
an inlet sensor affixed to the front pipe upstream of the catalytic converter wherein the inlet sensor and the outlet sensor are in communication with an engine control module; and
an outlet pipe affixed to the outlet of the catalytic converter.

2. The exhaust system of claim 1 wherein the oxygen sensor mount of the catalytic converter further comprises a threaded fastener and a shroud affixed to the catalytic converter.

3. The exhaust system of claim 2 wherein the shroud defines at least one row of apertures.

4. The exhaust system of claim 3 wherein the outlet sensor is operatively configured to determine the oxygen content of an exhaust gas flow proximate to the outlet sensor and to communicate with the engine control module.

5. The exhaust system of claim 4 wherein the at least one row of apertures defined in the shroud is operatively configured to disrupt the exhaust gas flow proximate to the outlet oxygen sensor.

6. The exhaust system of claim 5 wherein the at least one row of apertures is defined in at least a sectioned portion of a circumferential surface of the shroud.

7. The exhaust system of claim 6 wherein the at least one row of apertures is defined in a sectioned portion of about 25% or less of a circumferential surface of the shroud.

8. The exhaust system of claim 6 wherein the at least one row of apertures is a plurality of apertures formed about the entire circumferential surface of the shroud.

9. The exhaust system of claim 7 wherein the shroud is spaced apart from a metal shell of the sensor by a distance of approximately 5 mm to 10 mm.

10. A exhaust system for a vehicle comprising:
a catalytic converter having an entry and an outlet;
a first catalytic converter pipe affixed to the inlet of the catalytic converter and a second catalytic converter pipe affixed to the outlet of the catalytic converter, at least one of the first catalytic converter pipe and the second catalytic converter pipe having an integrated oxygen sensor mount with a shroud, the integrated sensor mount operatively configured to receive an oxygen sensor;
an exhaust manifold operatively configured to couple a vehicle combustion chamber to the entry of the catalytic converter via the first catalytic converter pipe; and
an engine control module in communication with the oxygen sensor.

11. The exhaust system as defined in claim 10 wherein the shroud defines a plurality of apertures operatively configured to mix a flow of exhaust gas as the flow of exhaust gas travels through the plurality of apertures of the shroud and a plurality of openings in a shell of the oxygen sensor.

12. The exhaust system as defined in claim 11 wherein the integrated oxygen sensor mount further comprises a boss configured to affix an orientation of the oxygen sensor.

13. The exhaust system as defined in claim 11 wherein the integrated oxygen sensor mount is formed in the first catalytic converter pipe and the oxygen sensor functions as an inlet oxygen sensor.

14. The exhaust system as defined in claim 11 wherein the integrated oxygen sensor mount is formed in the second catalytic converter pipe and the oxygen sensor functions as an outlet oxygen sensor.

15. The exhaust system as defined in claim 11 wherein the plurality of apertures are defined in one row of apertures in the shroud.

16. The exhaust system as defined in claim 11 wherein the plurality of apertures are defined in two rows of apertures in the shroud.

17. The exhaust system as defined in claim 11 wherein the plurality of apertures are formed about the entire circumferential surface of the shroud.

18. The exhaust system as defined in claim 11 wherein at least a portion of the plurality of apertures are offset from the plurality of openings defined in the metal shell of the oxygen sensor.

19. The exhaust system as defined in claim 13 further comprising a secondary oxygen sensor affixed to one of the catalytic converter or the second catalytic converter pipe, the secondary oxygen sensor being in communication with the electronic control module.

20. The exhaust system as defined in claim 14 further comprising a secondary oxygen sensor affixed to the first catalytic converter pipe, the secondary oxygen sensor being in communication with the electronic control module.
